(19) United States
(12) Patent Application Publication
(10) Pub. No.: US 2019/0277251 A1
(43) Pub. Date: Sep. 12, 2019

(54) ROTATORY AEROGENERATOR

(71) Applicant: Shih-Yu Huang, New Taipei City (TW)

(72) Inventor: Shih-Yu Huang, New Taipei City (TW)

(21) Appl. No.: 15/913,922

(22) Filed: Mar. 7, 2018

(51) Int. Cl. F03D 3/06; F03D 3/00; F03D 7/06

(52) U.S. Cl. CPC F03D 3/067; F03D 9/25; F03D 7/06; F03D 3/005

(57) ABSTRACT

The present invention a rotatory aerogenerator, which comprises: an axial rod; at least one first windward blade; at least one blade assembly; wherein each blade assembly component comprises: a first rod piece, a second windward blade and a second rod piece; wherein the first windward blade is pivotally connected with the first rod piece and the second rod piece for the flapping and folding activities of the second windward blade; and a supporting frame which top end is axially connected with the axial rod, so that the axial rod can rotate horizontally in the supporting frame. The rotatory aerogenerator of the present invention operates more efficiently and its upright design can be conveniently used in serial or in parallel and the user can use it in parallel by utilizing the same axial rod to achieve the effects of saving space and saving cost.

### (a) TECHNICAL FIELD OF THE INVENTION

The present invention is a rotatory aerogenerator, especially relates to an aerogenerator utilizing the flapping and folding activities of the windward blade to drive the axial rod to rotate rapidly. It operates more efficiently and achieves the applying effects of weight reducing, cost saving, and easy maintenance.

### (b) DESCRIPTION OF THE PRIOR ART

Among the existing aerogenerator, there is a “Aerogenerator” with the Republic of China Patent No. M540187U, which has the effect of reducing weight, improving efficiency, saving cost, and being easy to maintain.

However, the blade of the aerogenerator is a horizontal design, which results in a huge volume of the aerogenerator. It is not easy to use multiple aerogenerators to generate electricity power in serial or in parallel.

In view of this, the inventor of the present invention has devoted to researching and designing the system to provide an aerogenerator which similarly use the flapping and folding activities of the windward blade to drive the axial rod to rotate rapidly. But, in more compact size to achieve the effect of saving space, that is the inventive motivation of the present invention.

### SUMMARY OF THE INVENTION

The main purpose of the present invention is to provide an aerogenerator that can be conveniently used in serial or in parallel for the user, and its volume is more compact to achieve the effect of saving space.

To achieve above purpose, the present invention is a rotatory aerogenerator, which comprises: an axial rod; at least one first windward blade circularly set at one outside end of the axial rod; wherein the windward blade is equally arranged radially; at least one blade assembly; wherein each blade assembly component comprises: a first rod piece, a second windward blade and a second rod piece; wherein one side of the windward blade is connected with the first rod piece and the other side of the second windward blade is connected with the second rod piece; wherein the first windward blade is pivotally connected with the first rod piece and the second rod piece for the flapping and folding activities of the second windward blade; and a supporting frame which top end is axially connected with the axial rod, so that the axial rod can rotate horizontally in the supporting frame.

In this way, the wind power is received more efficiently. And, the rotatory aerogenerator of the present invention is an upright design, so that it can be conveniently used in serial or in parallel and the user can use it in parallel by utilizing the same axial rod to achieve the effects of saving space and saving cost.

The rotatory aerogenerator of the present invention as described above, one end of the axial rod is connected with a brake controller for providing the control to stop the rotation of the axial rod. And, the other end of the axial rod is connected with a power output unit. When the axial rod rotates, the power output unit is used to provide the power energy or the power for electricity generation.

The rotatory aerogenerator of the present invention as described above, wherein the material of the second windward blade is selected from anyone of the canvas, plastic and metal material.

### BRIEF DESCRIPTION OF THE DRAWINGS

FIG. 1 is a three-dimensional structure schematic diagram of the embodiment according to the present invention.

FIG. 2 is an action schematic diagram of the embodiment according to the present invention.

FIG. 3 is an action aerial view of the embodiment according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following detailed description provides a convenient illustration for implementing exemplary embodiments of the invention. Various changes to the described embodiments may be made in the function and arrangement of the elements described without departing from the scope of the invention as set forth in the appended claims.

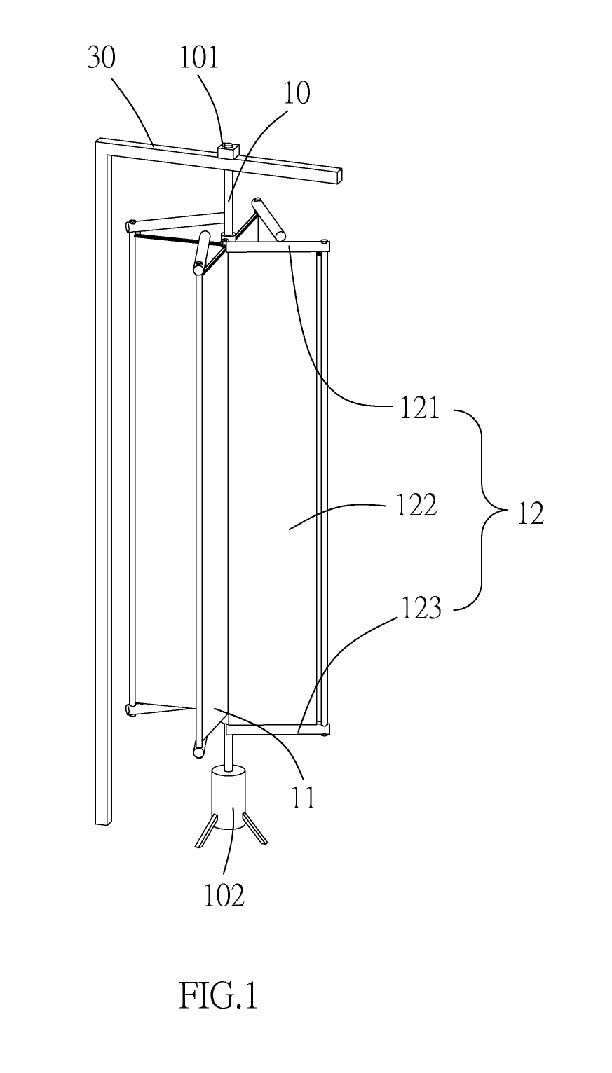

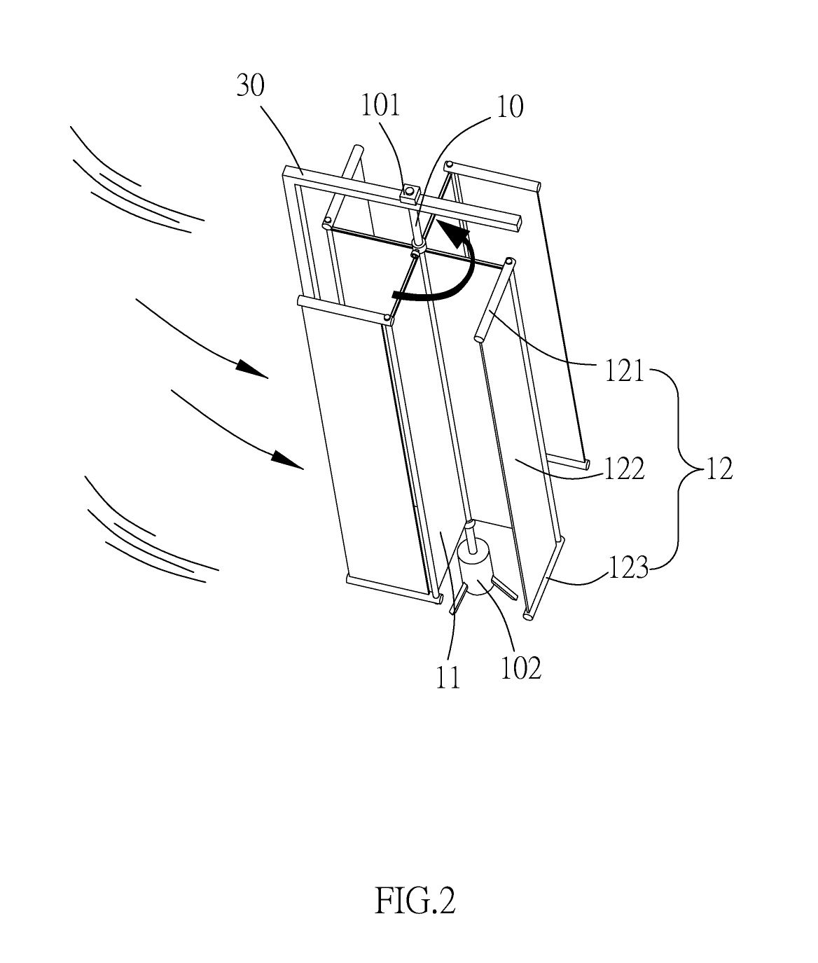

Please simultaneously refer to FIG. 1 and FIG. 2, the present invention is a rotatory aerogenerator, which comprises: an axial rod 10; at least one first windward blade 11 circularly set at one outside end of the axial rod 10; wherein the windward blade 11 is equally arranged radially; at least one blade assembly 12; wherein each blade assembly component comprises: a first rod piece 121, a second windward blade 122 and a second rod piece 123; wherein one side of the windward blade 122 is connected with the first rod piece 121 and the other side of the second windward blade 122 is connected with the second rod piece 123; wherein the first windward blade 11 is pivotally connected with the first rod piece 121 and the second rod piece 123 for the flapping and folding activities of the second windward blade 122; and a supporting frame 30 which top end is axially connected with the axial rod 10, so that the axial rod 10 can rotate horizontally in the supporting frame 30.

In this way, the wind power is received more efficiently. And, the rotatory aerogenerator of the present invention is an upright design, so that the user can place it side by side or utilizing the axial rod 10 to stack the rotatory aerogenerator of the present invention up and down. This means that the upright design of the rotatory aerogenerator of the present invention can be convenient for the user to use by the serial or parallel way, so as to achieve the effects of saving space and saving cost.

As described above, one end of the axial rod 10 is connected with a brake controller 101 for providing the control to stop the rotation of the axial rod 10. The other end of the axial rod 10 is connected with a power output unit 102. When the axial rod 10 rotates, the power output unit 102 is used to provide the power energy. Therefore, the rotatory aerogenerator of the present invention can achieve the effect of electricity generation by outputting the rotation power of the axial rod 10 through the power output unit 102.

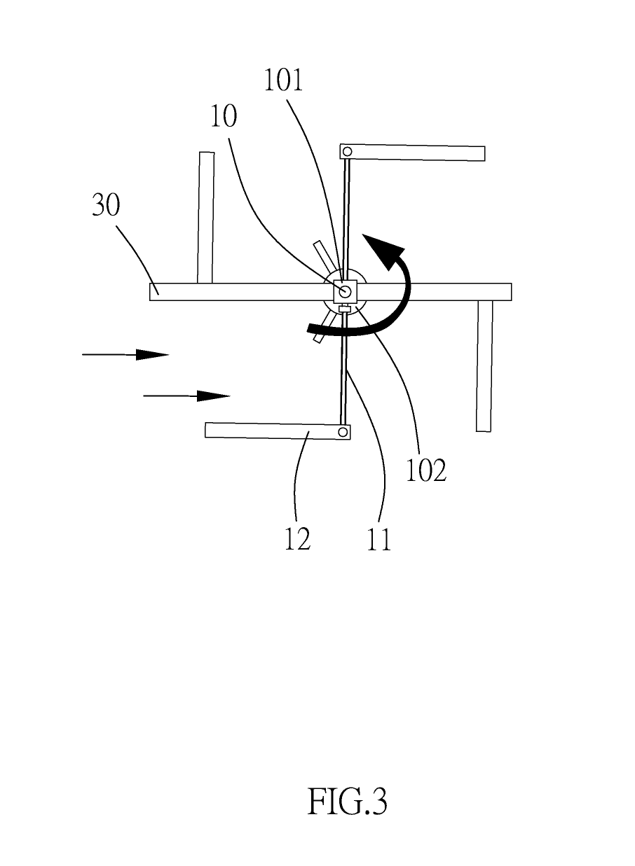

Please refer to FIG. 2 and FIG. 3, when the wind blows to the rotatory aerogenerator of the present invention, the first windward blade 11 become the wind receiving surface and will flap, fold, and displace along with the direction of the airflow. The first rod piece 121 and the second rod 123 pivotally connected with the first windward blade 11 are also rotated synchronously, which will automatically close and cover the second windward blade 122 to capture the wind force under its influence. When the first windward blade 11 is leeward, the second windward blade 122 will be opened up by the wind without producing resistance. As the airflow is stronger, the folding angle of the second windward blade 122 is also increased, so that the radius of gyration can be reduced to increase the rotational speed of the axial rod 10. In design considerations, a canvas material is selected for the second windward blade 122 to reduce the weight, and the flapping and folding activities of the windward blade 122 will reduce the frictional resistance and thus improve the performance of the rotatory aerogenerator. To keep the rotatory aerogenerator of the present invention stationary, the brake controller 101 is used to stop the rotation of the axial rod 10. In this way, the rotatory aerogenerator of the present invention utilizes the wind to drive the first windward blade 11 and the blade assembly 12 to rotate. At the same time, each of the blade assembly 12 also separately proceed the flapping and folding activities to make the axial rod 10 rotated rapidly to achieve the effect of labor saving.

I claim:

1. A rotatory aerogenerator, which comprises:
an axial rod;
at least one first windward blade circularly set at one outside end of the axial rod; wherein the windward blade is equally arranged radially;
at least one blade assembly; wherein each blade assembly component comprises: a first rod piece, a second windward blade and a second rod piece; wherein one side of the windward blade is connected with the first rod piece and the other side of the second windward blade is connected with the second rod piece; wherein the first windward blade is pivotally connected with the first rod piece and the second rod piece for the flapping and folding activities of the second windward blade; and
a supporting frame which top end is axially connected with the axial rod, so that the axial rod can rotate horizontally in the supporting frame.

2. The rotatory aerogenerator according to claim 1, wherein one end of the axial rod is connected with a brake controller for providing the control to stop the rotation of the axial rod and the other end of the axial rod is connected with a power output unit to provide the power energy when the axial rod rotates.

3. The rotatory aerogenerator according to claim 1, wherein the material of the second windward blade is selected from anyone of the canvas, plastic and metal material.
